(19) United States
(12) Patent Application Publication
(10) Pub. No.: US 2026/0084770 A1
(43) Pub. Date: Mar. 26, 2026

(54) Quick Release Mounting Plate Assembly

(71) Applicant: Dimitri Cretikos, Santa Ana, CA (US)

(72) Inventor: Dimitri Cretikos, Santa Ana, CA (US)

(21) Appl. No.: 18/898,336

(22) Filed: Sep. 26, 2024

(51) Int. Cl. B62J 7/08

(52) U.S. Cl. CPC B62J 7/08

(57) ABSTRACT

A mounting plate assembly for securing an item to a rack of a vehicle has a mounting plate and a locking latch secured thereto. The locking latch has a main body having a grooved passageway at its lower end. The locking latch also has a curved catch having a free end and an opposing connecting end that is pivotably connected to the lower end of the main body, with the free end having a locking hole. The curved catch is shaped to define a curved inner side such that, when combined with the grooved passageway, together define a generally circular passageway when the curved catch is closed. The locking latch further includes a release knob coupled with the main body and having a locking pin that releasably engages the locking hole of the curved catch. The circular passageway is adapted to receive the at least one bar when the mounting plate is secured to the rack.

### BACKGROUND OF THE INVENTION

### 1. Field of the Invention

The present invention relates to a mounting plate assembly that is used to secure saddlebags and items to a rack such as found on motorcycles and other powersport vehicles, and in particular, to a latch that is used with the mounting plate assembly to enable quick locking and release of the mounting plate to and from a rack.

### 2. Description of the Prior Art

There has always been a need for effective mechanisms for securing loads or objects, such as backpacks, and other bags, to vehicles such as bicycles, motorcycles and other powersport vehicles. For example, pannier racks are commonly used for securing bags to a motorcycle. The mounting plate is a mounting system that allows a rider to attach pannier bags to the motorcycle rack. They are usually made of metal or alloy and are attached to the motorcycle above the rear wheels.

Thus, there remains a need for a mounting plate assembly that can be quickly and effectively secured to and removed from a rack of a vehicle.

### SUMMARY OF THE DISCLOSURE

The present invention is directed towards a quick release mounting plate assembly that is adapted for quickly and effectively securing a bag to and removing it from a rack of a vehicle.

In order to accomplish the objects of the present invention, there is provided a mounting plate assembly for securing an item to a rack of a vehicle, such as a motorcycle. The mounting plate has a plurality of mounting slots, at least one mounting foot removably attached to at least one of the mounting slots, and a locking latch. The locking latch has a main body having a left wall and a right wall that are parallel with each other, with a curved groove section cut from a lower part of each of the left wall and the right wall, with the curved groove sections together defining a grooved passageway. The locking latch also has a curved catch having a free end and an opposing connecting end that is pivotably connected to the lower part of the left wall and the right wall, with the free end having an end surface and a locking hole extending from the end surface, and wherein the curved catch is shaped to define a curved inner side such that, when combined with the grooved passageway, together define a generally circular passageway when the curved catch is closed. The locking latch further includes a release knob coupled with the main body and having a locking pin that extends into the grooved passageway to releasably engage the locking hole of the curved catch. A biasing member carried on the locking pin normally biases the locking pin towards the circular passageway. The circular passageway is adapted to receive the at least one bar when the mounting plate is secured to the rack.

### BRIEF DESCRIPTION OF THE DRAWINGS

FIG. 1 is a rear perspective view of a mounting plate assembly of the present invention.

FIG. 2 is a perspective view showing the mounting feet of the mounting plate being pivoted on to a bar of a pannier rack that is secured to a motorcycle.

FIG. 3 shows how the mounting plate is secured to the pannier rack in FIG. 2.

FIG. 4 shows the mounting plate secured to the pannier rack in FIG. 2.

FIG. 5 is a front perspective view of the mounting plate assembly of FIG. 1.

FIG. 6 is an exploded perspective view of the locking latch for the mounting plate assembly of FIG. 1.

FIG. 7 is a perspective cut-out view of the assembled locking latch of FIG. 6 shown in the unlocked position.

FIG. 8 is a perspective cut-out view of the assembled locking latch of FIG. 6 shown in the locked position.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention is described in use with a pannier rack of a motorcycle, however, the mounting plate assembly 10 of the present invention can also be used to secure saddlebags and items to a rack that can be used with any two-wheel or four-wheel vehicle, including bicycles, motorcycles and other powersport and off-road vehicles.

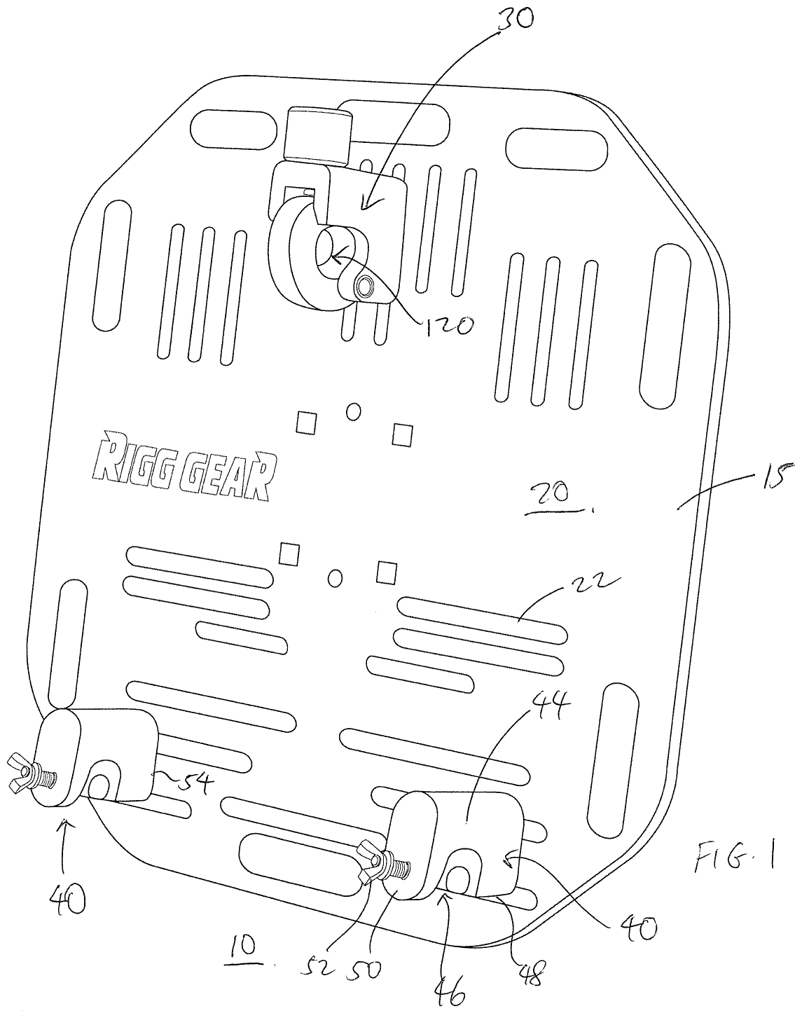

Referring to FIGS. 1-5, the mounting plate assembly 10 of the present invention has a mounting plate 15 that is adapted to be secured to a bar 12 of a tubular or oval pannier rack 14 that is secured to a portion of a motorcycle. A rear or inner surface 20 of the mounting plate 15 is adapted to face the pannier rack 14, and has a locking latch 30 removably and adjustably secured to selected mounting slots 22 of the locking latch 30. In addition, one or more mounting feet 40 are also removably and adjustably secured to other selected mounting slots 32 of the locking latch 30.

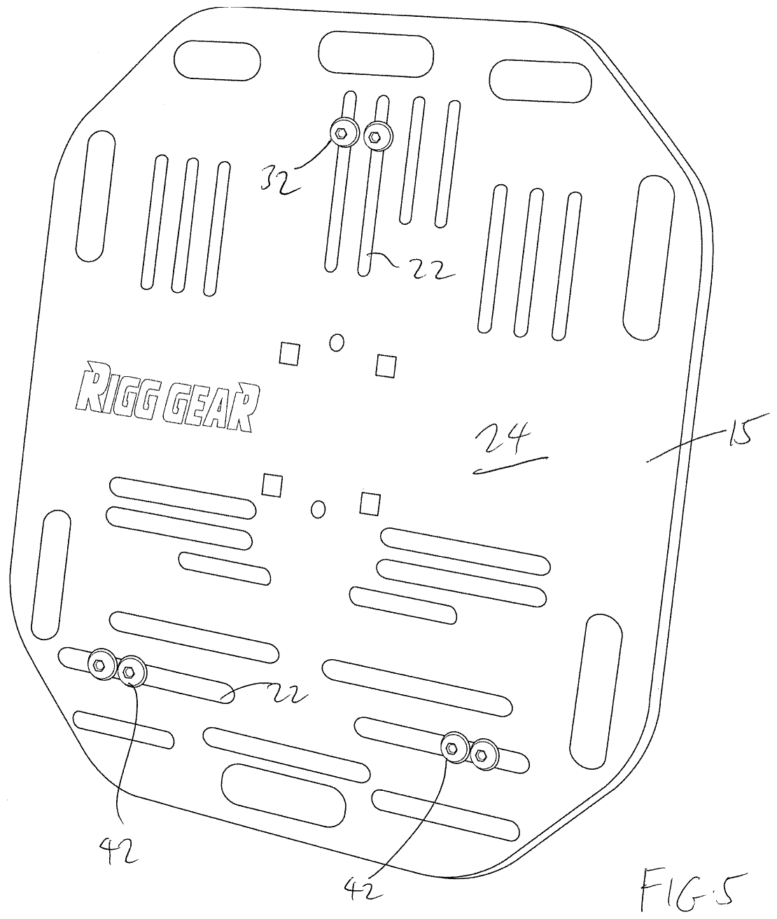

In use, the locations of the locking latch 30 and the mounting feet 40 can be adjusted depending on the positions of the bars 12 of the pannier rack 14 and other factors. As shown in FIG. 5, locking threads or screws 32 and 42 are used to secure the locking latch 30 and the mounting feet 40, respectively, to the mounting plate 15 via the front or outer-facing surface 24.

Each mounting foot 40 has a generally C-shaped body 44 with a groove 46 cut from a bottom-facing side 48. The groove 46 is adapted to receive a part of the bar 12. A bore (not shown) extends from an inner-facing side 50 to the groove 46, and a stabilization screw 52 can be used to tighten the screw 52 against the bar 12. A connection side 54 of the mounting foot 40 is flat and is adapted to rest against the inner surface 20 of the mounting plate 15 when secured by the screw 42.

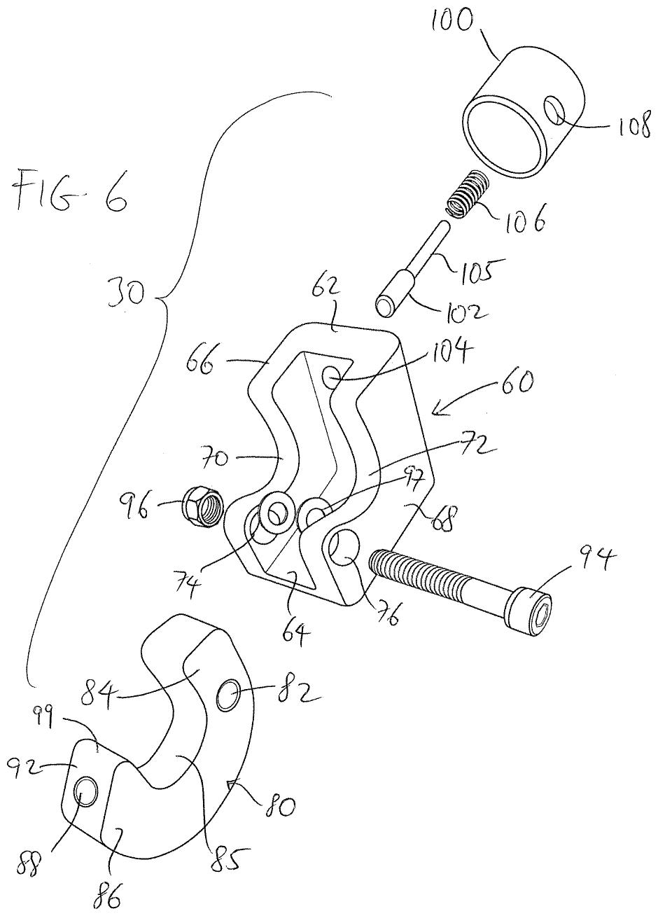

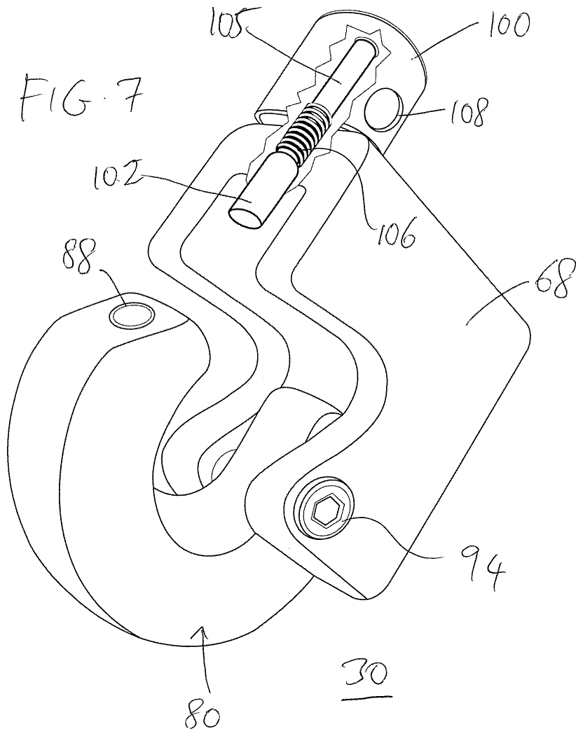

Referring to FIGS. 6-9, the locking latch 30 has a generally hollow L-shaped main body 60 having a top wall 62, and three vertical walls that extend from the top wall 62: a connecting wall 64 that is adapted to rest against the inner surface 20 of the mounting plate 15, a left wall 66 and a right wall 68 each extending from opposite vertical sides of the connecting wall 64 and parallel with each other. A curved groove section 70 and 72 is cut from a lower part of the left wall 66 and the right wall 68, respectively, and together define a grooved passageway.

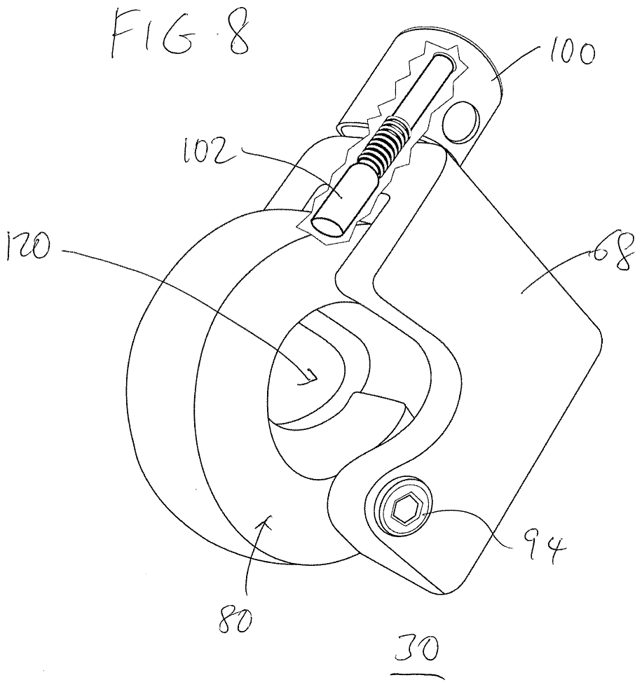

The locking latch 30 also has a curved catch 80 that is pivotably coupled via aligned holes 74 and 76 to the lower part of the left wall 66 and the right wall 68, respectively, such that a threaded bolt or screw 94 can extend through the holes 74 and 76, and a through-hole 82 that is positioned at a connecting end 84 of the catch 80. A nut 96 can be used to secure the screw 94, and washers 97 can be provided to facilitate the pivoting connection. The other free end 86 of the catch 80 has a locking hole 88 extending from an angled end surface 92 thereof. The catch 80 is shaped to define a curved inner side 85 that, when combined with the grooved passageway defined by the curved groove section 70 and 72, will together provide or define a generally circular passageway 120 (see FIG. 8) for receiving a bar 16 of the pannier rack 14. In addition, a curved transition 99 is provided between the curved inner side 85 and the end surface 92.

A release knob 100 is positioned above the top wall 62. A locking pin 102 is positioned in the space inside the main body 60 and has a shaft 105 that extends through an opening 104 in the top wall 62 to be secured to the top of the knob 100. A spring 106 is seated on a shaft 105 and has one end that abuts the top wall 62, thereby normally biasing the locking pin 102 into the interior space defined by the walls 62, 66 and 68. The knob 100 also has an optional locking bore 108 that extends therethrough, and is adapted to receive a lock pin (not shown). When the lock pin extends through the locking bore 108, the knob 100 is locked in that the knob 100 cannot be raised, so that the locking latch 30 also cannot be opened.

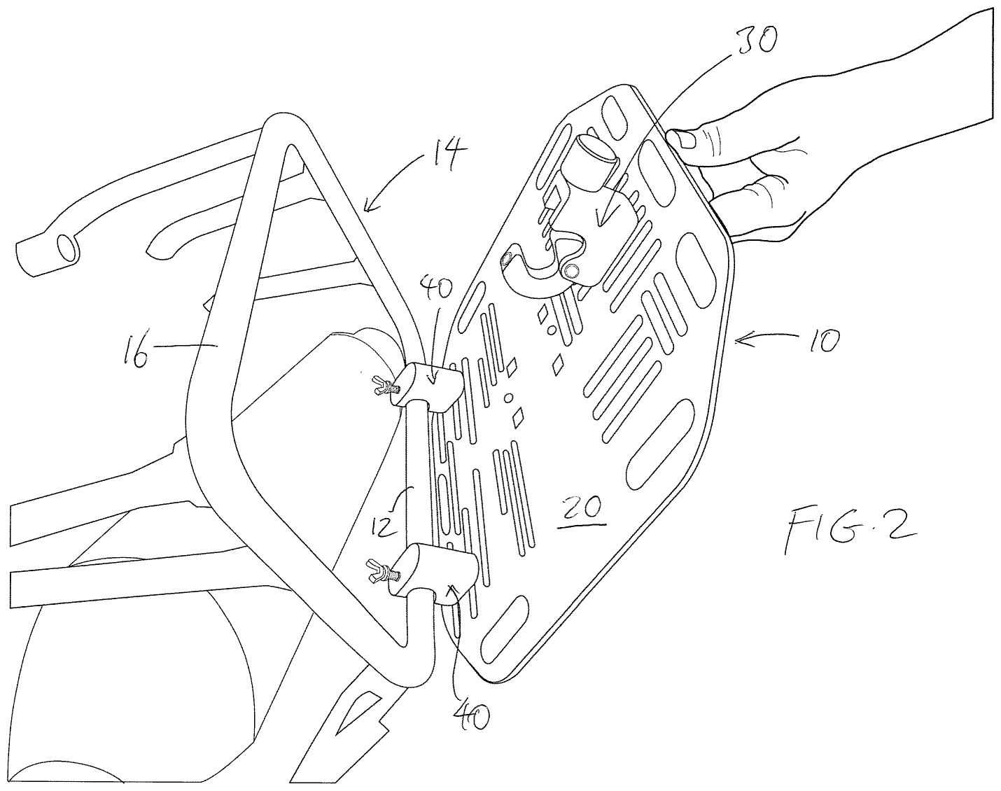

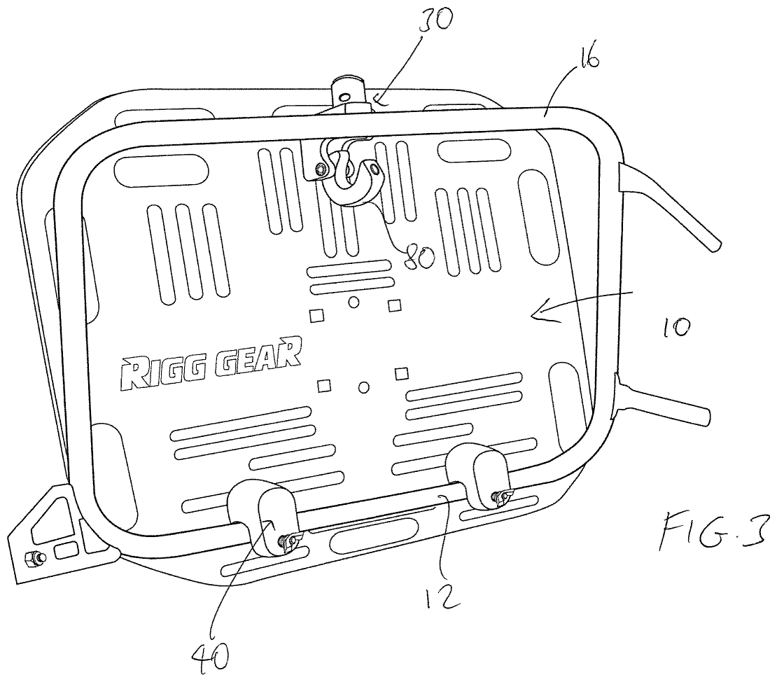

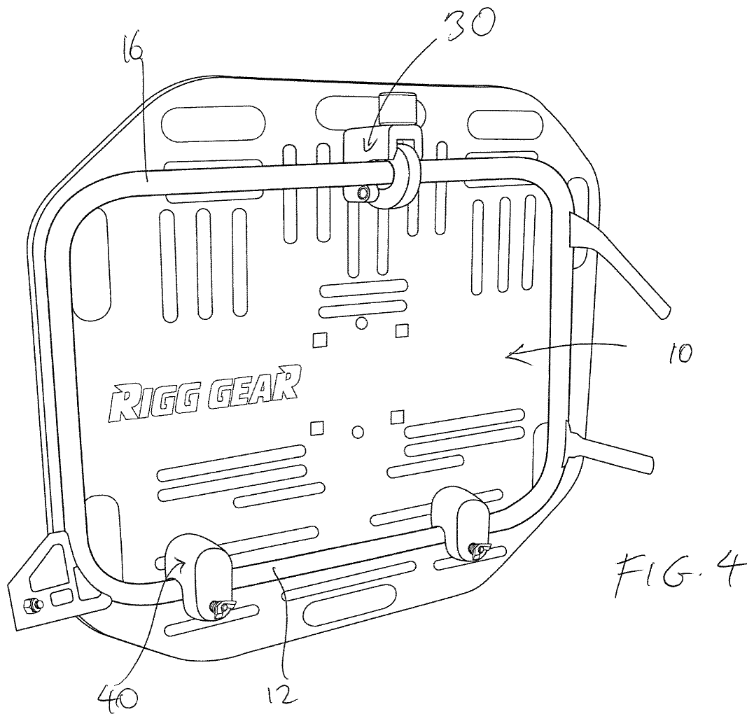

In use, the locking latch 30 and the mounting feet 40 are positioned at the desired mounting slots 22, and then locking screws 32 and 42 are used to secure the locking latch 30 and the mounting feet 40 to the mounting plate 15 via the front or outer-facing surface 24. A bag or other item (not shown) is then secured to the outer-facing surface 24 of the mounting plate 15 using techniques that are well-known in the art. Next, as shown in FIG. 2, the bar 12 of the pannier rack 14 is positioned inside the grooves 46 of the mounting feet 40, and then the mounting rack assembly 10 is pivoted towards the pannier rack 14 (see FIG. 3). At this point, the catch 80 is in its opened position (see FIG. 3) so that the bar 16 of the pannier rack 14 can be positioned inside the passageway 120. As the bar 16 enters the passageway 120, the bar 16 pushes against the end 84 of the catch 80, causing the catch 80 to pivot so that the free end 86 pivots upwardly until the free end of the locking pin 102 engages the end surface 82. Because the transition 99 is curved, the free end of the locking pin 102 can be slid along the transition 99 towards the angled end surface 92 until the free end of the locking pin 102 (which is normally biased by spring 106) is aligned with, and enters, the locking hole 88. This is the locked position for the locking latch 30 which is shown in FIG. 4. The spring 106 normally biases the locking pin 102 into the locking hole 88 so that once the locking pin 102 is received inside the locking hole 88, the locking latch 30 is locked and the bar 16 cannot be removed from the passageway unless the knob 100 is lifted. This secures the bar 16 inside the passageway 120 of the locking latch 30, and therefore secures the mounting rack 10 to the pannier rack 14.

To remove the mounting rack 10, the rider simply lifts the knob 100, which pulls the locking pin 102 out of the locking hole 88 (this pulling action counters the natural bias of the spring 106) and allows the end 84 of the catch 80 to pivot away from the locking pin 102, thereby opening the passageway 120 so that the bar 16 can be removed.

Thus, the locking latch 30 provides a simple yet effective mechanism for quickly securing and releasing a bar of a pannier rack so that the mounting rack 10 that is secured to the locking latch 30 be quickly secured to the pannier rack by clicking the bar 16 into place, and be quickly removed from the bar 16 by lifting the knob 100.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A mounting plate assembly for securing an item to a rack of a vehicle, the rack having at least one bar, the assembly comprising:
a mounting plate having a plurality of mounting slots;
at least one mounting foot removably attached to at least one of the plurality of mounting slots;
a locking latch having:
a main body having a left wall and a right wall that are parallel with each other, with a curved groove section cut from a lower part of each of the left wall and the right wall, with the curved groove sections together defining a grooved passageway;
a curved catch having a free end and an opposing connecting end that is pivotably connected to the lower part of the left wall and the right wall, wherein the free end has an end surface and a locking hole extending from the end surface, and wherein the curved catch is shaped to define a curved inner side such that, when combined with the grooved passageway, together define a generally circular passageway when the curved catch is closed;
a release knob coupled with the main body and having a locking pin that extends into the grooved passageway to releasably engage the locking hole of the curved catch;
a biasing member carried on the locking pin and normally biasing the locking pin towards the circular passageway; and
wherein the circular passageway is adapted to receive the at least one bar when the mounting plate is secured to the rack.

2. The assembly of claim 1, wherein the main body has a top wall, and the biasing member is positioned inside the main body and has a first end that engages the top wall and an opposite second end that biases the locking pin.

3. The assembly of claim 2, wherein the locking pin has a shaft that carries the biasing member, the shaft extending through the top wall and secured to the release knob.

4. The assembly of claim 1, wherein the end surface is angled, and a curved transition is provided between the end surface and the curved inner side.

5. An assembly, comprising:
a vehicle having a rack, the rack having at least one bar;
a mounting plate assembly, comprising:
a mounting plate having a plurality of mounting slots;
at least one mounting foot removably attached to at least one of the plurality of mounting slots;
a locking latch having:
a main body having a left wall and a right wall that are parallel with each other, with a curved groove section cut from a lower part of each of the left wall and the right wall, with the curved groove sections together defining a grooved passageway;
a curved catch having a free end and an opposing connecting end that is pivotably connected to the lower part of the left wall and the right wall, wherein the free end has an end surface and a locking hole extending from the end surface, and wherein the curved catch is shaped to define a curved inner side such that, when combined with the grooved passageway, together define a generally circular passageway when the curved catch is closed;
a release knob coupled with the main body and having a locking pin that extends into the grooved passageway to releasably engage the locking hole of the curved catch;
a biasing member carried on the locking pin and normally biasing the locking pin towards the circular passageway; and
wherein the at least one bar is received inside the circular passageway when the mounting plate is secured to the rack.

6. The assembly of claim 5, wherein the main body has a top wall, and the biasing member is positioned inside the main body and has a first end that engages the top wall and an opposite second end that biases the locking pin.

7. The assembly of claim 6, wherein the locking pin has a shaft that carries the biasing member, the shaft extending through the top wall and secured to the release knob.

8. The assembly of claim 5, wherein the end surface is angled, and a curved transition is provided between the end surface and the curved inner side.
